(19) United States
(12) Patent Application Publication
(10) Pub. No.: US 2003/0223581 A1
(43) Pub. Date: Dec. 4, 2003

(54) Cipher block chaining unit for use with multiple encryption cores

(76) Inventor: Bedros Hanounik, Cupertino, CA (US)

Correspondence Address: BUCKLEY, MASCHOFF, TALWALKAR, & ALLISON, 5 ELM STREET, NEW CANAAN, CT, 06840, US

(21) Appl. No.: 10/159,203

(22) Filed: May 30, 2002

(51) Int. Cl. H04K 1/06; H04K 1/04

(52) U.S. Cl. 380/37

(57) ABSTRACT

According to some embodiments, a cipher block chaining unit is provided to support multiple encryption cores.

### BACKGROUND

To protect and/or authenticate information, it is known that a sender can encrypt data. For example, the sender may encrypt an original message of “plaintext” (P) to create ciphertext (C), such as by encrypting P using an encryption key in accordance with the Data Encryption Standard (DES) defined by American National Standards Institute (ANSI) X3.92 “American National Standard for Data Encryption Algorithm (DEA)” (1981). The sender can then securely transmit C to a recipient. The recipient decrypts C to re-create the original P (e.g., using a decryption key in accordance with DES).

In a “block” encryption process, the original P is divided into blocks of information ( . . . Pᵢ₋₁, Pᵢ, Pᵢ₊₁, . . . ). For example, DES divides P into a number of 64-bit blocks. The blocks of plaintext are then used to create blocks of ciphertext ( . . . Cᵢ₋₁, Cᵢ, Cᵢ₊₁, . . . ). To more securely protect P, a Cipher Block Chaining (CBC) encryption process uses information about one block to encrypt or decrypt another block (thus, the blocks are “chained” together). FIG. 1 is an overview of such a CBC encryption process 100 wherein an encryption algorithm (E) 110 operates on an input to generate Cᵢ. In particular, the input to E 110 is the current block of plaintext (Pᵢ) combined with the previous block of ciphertext (Cᵢ₋₁) via an exclusive OR (XOR) operation 120.

Similarly, FIG. 2 is an overview of a CBC decryption process 200 wherein a decryption algorithm (D) 210 operates on a current block of ciphertext (Cᵢ) to generate an output. The output from D 210 is combined with the previous block of ciphertext (Cᵢ₋₁) via an XOR operation 220 to re-create the original Pᵢ.

When a number of different messages are being encrypted or decrypted, it may be impractical to provide a separate encryption device for each message. As a result, a single encryption device may include a number of different encryption “cores,” with each core being able to simultaneously encrypt or decrypt a different message. FIG. 3 is a block diagram of such an encryption device 300. The encryption device 300 includes four encryption cores 310, 311, 312, 313—each able to receive an input and provide an output in accordance with an encryption process (i.e., a process that encrypts or decrypts data).

To support a CBC encryption process, each encryption core 310, 311, 312, 313 is associated with a different CBC unit 320, 321, 322, 323. A CBC unit may, for example, combine a current block of plaintext (Pᵢ) with a previous block of ciphertext (Cᵢ₋₁) via an XOR operation and provide the result to its associated encryption core (e.g., when the encryption core is encrypting data). A CBC unit may also combine a previous block of ciphertext (Cᵢ₋₁) with information received from its associated encryption core via an XOR operation (e.g., when the encryption core is decrypting data).

Providing a separate CBC unit for each encryption core, however, may limit the performance of the encryption device 300. For example, each CBC unit will occupy area in the encryption device 300, limiting the number of encryption cores that can be included (and the number messages that can be encrypted or decrypted).

Moreover, a CBC unit may be inefficiently designed given the environment in which it is implemented. For example, a CBC unit may be designed for a Field-Programmable Gate Array (FPGA). An FPGA is an integrated circuit that can be programmed after manufacture by connecting various Configurable Logic Blocks (CLBs), such as look-up tables, together in different ways. A design for a CBC unit may inefficiently use such CLBs, especially if different types of encryption processes need to be supported (e.g., encryption and decryption, chaining and non-chaining).

### BRIEF DESCRIPTION OF THE DRAWINGS

FIG. 1 is an overview of a CBC encryption process.

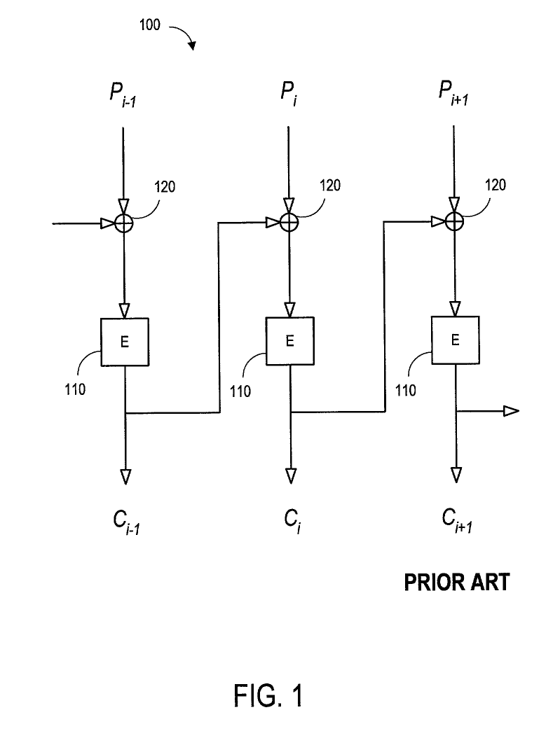

FIG. 2 is an overview of a CBC decryption process.

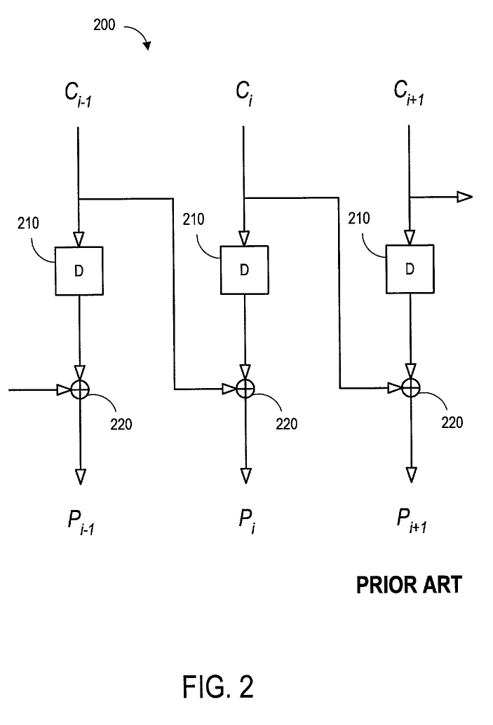

FIG. 3 is a block diagram of an encryption device having multiple encryption cores.

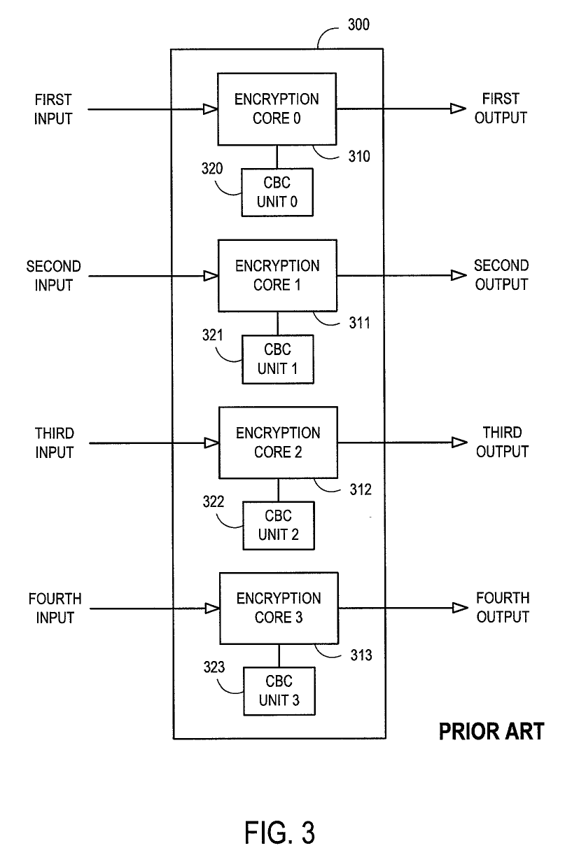

FIG. 4 is a block diagram of an encryption device having multiple encryption cores according to some embodiments.

FIG. 5 is a flow chart of a method of facilitating an encryption process according to some embodiments.

FIG. 6. illustrates one example of a CBC unit that can support four encryption cores according to some embodiments.

FIG. 7 illustrates how information is stored in a memory unit according to one embodiment.

### DETAILED DESCRIPTION

Some of the described embodiments are associated with an “encryption process.” As used herein, the phrase “encryption process” may refer to a process that encrypts or decrypts data. Examples of an encryption process include DES, triple-DES as defined by ANSI X9.52 “Triple Data Encryption Algorithm Modes of Operation” (1998), and Advanced Encryption Standard (AES) as defined by Federal Information Processing Standards (FIPS) publication 197 (2002). Details about these, and other, encryption processes can be found in Bruce Schneier, “Applied Cryptography” (2nd Ed., 1996).

Encryption Device

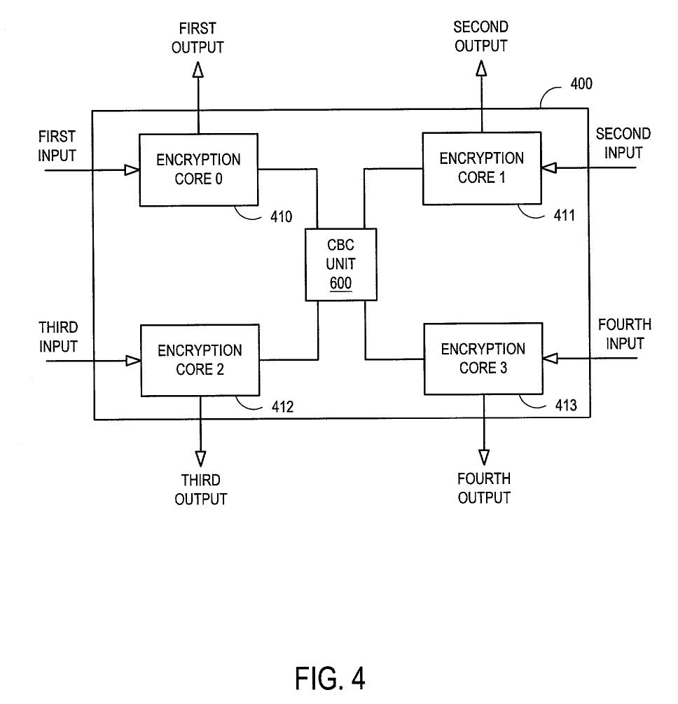

FIG. 4 is a block diagram of an encryption device 400 according to some embodiments. The encryption device 400 includes four encryption cores 410, 411, 412, 413—each able to receive an input and provide an output in accordance with an encryption process. In particular, the encryption cores 410, 411, 412, 413 may generate ciphertext output data based on plaintext input data and a key and/or generate plaintext output data based on ciphertext input data and a key. Moreover, the encryption cores 410, 411, 412, 413 may support a block encryption process, a chaining mode, and/or a non-chaining mode (e.g., in accordance with DES or triple-DES).

To support all four of the encryption cores 410, 411, 412, 413, a single CBC unit 600 is provided. The CBC unit 600 may, for example, combine a current block of plaintext (Pᵢ) with a previous block of ciphertext (Cᵢ₋₁) via an XOR operation and provide the result to a target encryption core that is performing an encryption algorithm. In this case, the CBC unit 600 may also transfer the result (Cᵢ) directly from the encryption core to memory.

The CBC unit 600 may also transfer a current block of ciphertext (Cᵢ) directly from memory to an encryption core that is performing a decryption algorithm. In this case, the CBC unit 600 may combine information received from the encryption core with a previous block of ciphertext (Cᵢ₋₁) via an XOR operation and provide the result (Pᵢ) directly to memory.

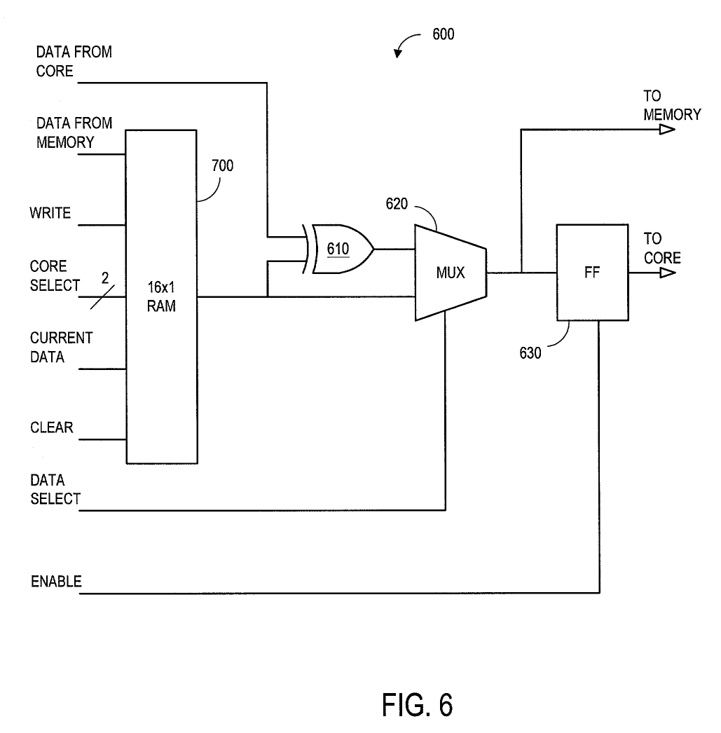

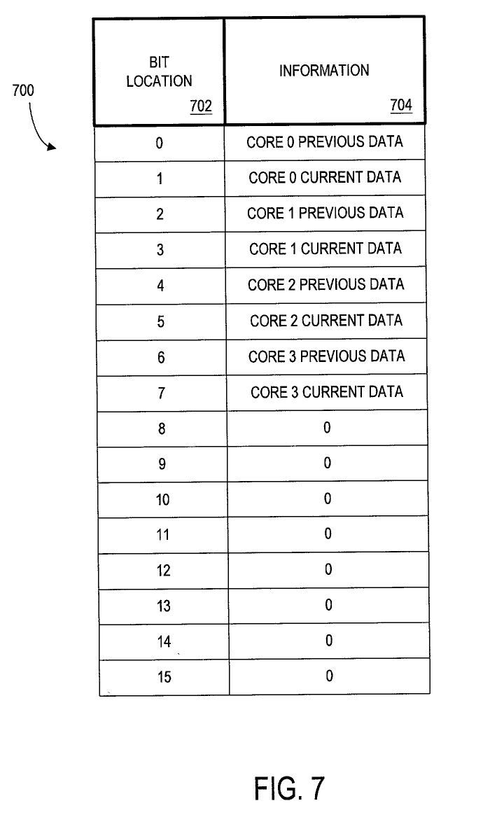

According to some embodiments, the CBC unit 600 is implemented in a FPGA environment. One example of a CBC unit 600 that supports four encryption cores using a single FPGA slice for each bit of input data is described with respect to FIGS. 6 and 7. According to other embodiments, the CBC unit 600 is instead implemented in an Application Specific Integrated Circuit (ASIC) environment.

Note that each encryption core might require 16 processor cycles to handle a single data block (e.g., a 64-bit Pᵢ or C₁) when using a standard DES encryption process. When using a triple-DES encryption process, an encryption core may need 48 processor cycles to handle each data block. The CBC unit 600, on the other hand, might process a data block in one processor cycle. As a result, the CBC unit 600 will typically be available when needed by any of the four encryption cores 410, 411, 412, 413.

Encryption Method

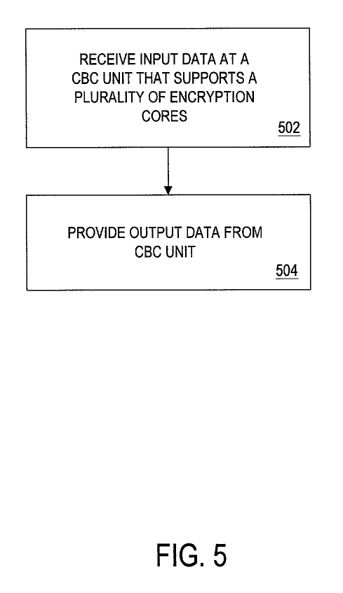

FIG. 5 is a flow chart of a method of facilitating an encryption process according to some embodiments. The method may be performed, for example, by the CBC unit 600 shown in FIG. 4.

At 502, the CBC unit 600 receives input data (i.e., from memory or an encryption core). The CBS unit 600 then processes the input data and provides appropriate output data at 504 (i.e., to memory or an encryption core).

When an encryption core is encrypting data, for example, the CBC unit 600 may receive current plaintext data from memory (Pᵢ), combine this data with previous ciphertext data (Cᵢ₋₁), and provide the result to the encryption core (Pᵢ XOR Cᵢ₋₁). In this case, the CBC unit 600 may also receive data from the encryption core (Cᵢ) and transfer the data directly to memory without performing a chaining operation.

When an encryption core is decrypting data, the CBC unit 600 may receive data from memory (Cᵢ) and transfer the data directly to an encryption core without performing a chaining operation. In this case, the CBS unit 600 may also receive data from the encryption core, combine this data with previous ciphertext information (Cᵢ₋₁), and provide the result to memory (Pᵢ).

Example of CBC Unit

FIG. 6. illustrates one example of a CBC unit 600 that can support four encryption cores. In particular, the circuit illustrated in FIG. 6 can receive one bit of input data from, and provide one bit of output data to, any of the four encryption cores or memory. Thus, the CBC unit 600 may include 64 of these circuits to support a 64-bit block of plaintext or ciphertext.

The CBC unit 600 includes a memory unit 700, such as a 16×1 Random Access Memory (RAM) unit. The memory unit 700 receives data from memory and a write signal that controls whether or not the data from memory will be stored. The memory unit 700 also receives a two-bit encryption core select signal, a current data signal, and a clear signal.

FIG. 7 illustrates how information 704 is stored in the memory unit 700 according to one embodiment. As can be seen, the memory unit 700 stores one bit of previous data and one bit of current data for each of the four encryption cores. For example, bit location “4” stores one bit of previous data for encryption core 2 and bit location “5” stores one bit of current data for that encryption core. The remaining eight bits in the memory unit 700 (i.e., bit locations “8” through “5”) each store a zero bit.

According to this embodiment, the four bits needed to address each bit location 702 would be defined as follows: (clear signal, two-bit encryption core select signal, current data signal). For example, by not asserting the clear signal, selecting encryption core 2 (“10”), and asserting the current data signal (i.e., “0101”), bit location “5” is addressed. Of course, whenever the clear signal is asserted (“1xxx”), the addressed location will contain a zero bit.

Note that the illustration and accompanying description of the memory unit 700 presented herein is exemplary, and any number of other arrangements could be employed besides those suggested by FIG. 7 (e.g., the first eight bit locations could each store a zero bit while the remaining eight bit locations store current and previous data for each encryption core).

Referring again to FIG. 6, the CBC unit 600 also includes an XOR gate 610. The XOR gate 610 receives data from encryption core as well as an output from the memory unit 700.

The output of the XOR gate 610 is provided to a multiplexer (MUX) 620. The multiplexer 620 also receives the output from the memory unit 700. Whether the multiplexer 620 will output information from the XOR gate 610 or the memory unit 700 is controlled by a data select signal.

The output of the multiplexer 620 is provided both to memory and to a storage unit 630, such as a digital flip flop register controlled by an enable signal. The output of the storage unit 630 is provided to encryption core.

According to some embodiments, the CBC unit 600 is implemented using a single FPGA slice for each bit of input data. For example, the memory unit 700 may be implemented via a function generator, the XOR gate 610 and multiplexer 620 may be implemented via a lookup table, and the storage unit 630 may be implemented via a flip flop. An example of an FPGA environment that may be appropriate for such an implementation is available from XILINX®.

According to some embodiments, the CBC unit 600 supports an encryption core that is encrypting data by: (i) transferring data from memory to the encryption core with chaining, and (ii) transferring data from the encryption core to memory without chaining. The CBC unit 600 may also support an encryption core that is decrypting data by: (i) transferring data from memory to the encryption core without chaining, and (ii) transferring data from the encryption core to memory with chaining.

Encryption Process: Memory to Encryption Core with Chaining

When an encryption core is encrypting information, the CBC unit 600 may receive data from memory (i.e., input data Pᵢ), combine this data with previous information (Cᵢ₋₁), and provide the result (Pᵢ XOR Cᵢ₋₁) to a target encryption core.

In this case, the current plaintext data to be encrypted (Pᵢ) is copied to the memory unit 700 by asserting the write and current data signals, not asserting the clear signal, and selecting the target encryption core via the two-bit encryption core select signal. For example, if the target encryption core is “2,” the write signal, the clear signal (“0”), the encryption core select signal (“10”), and the current data signal (“1”) would indicate that the memory unit 700 should store the current plaintext information 704 at bit location “5.”

In this way, the XOR gate 610 receives the current plaintext data from the memory unit 700 along with data from the encryption core (Cᵢ₋₁). In addition, the data select signal instructs the multiplexer 620 to output data received from the XOR gate 610 (as opposed to data received directly from the memory unit 700), and that result (i.e., output data Pᵢ XOR Cᵢ₋₁) is provided to the target encryption core via the storage device 630.

Encryption Process: Encryption Core to Memory Without Chaining

After the encryption core encrypts the data, the CBC unit 600 will receive information from the encryption core (i.e., input data Cᵢ) and transfer the information directly to memory without performing a chaining operation.

To do so, the clear signal to the memory unit 700 is asserted. This causes one of the zero bits stored in the memory unit 700 (i.e., any of bit locations “8” through “15”) to be provided from the memory unit 700 to the XOR gate 610. As a result, the output of the XOR gate simply equals the data it receives from the encryption core (Cᵢ). In addition, the data select signal instructs the multiplexer 620 to output data received from the XOR gate 610 (as opposed to data received directly from the memory unit 700), and that result (i.e., output data Ci) is provided directly to memory.

Decryption Process: Memory to Encryption Core Without Chaining

When an encryption core is decrypting information, on the other hand, the CBC unit 600 may receive information from memory (i.e., input data Cᵢ) and transfer the information directly to the encryption core without performing a chaining operation.

In this case, the current ciphertext data to be decrypted (Cᵢ) is copied to the memory unit 700 by asserting the write and current data signals, not asserting the clear signal, and selecting the target encryption core via the two-bit encryption core select signal.

The output from the memory unit 700 is then routed to the storage unit 630 via the data select signal (i.e., the data select signal instructs the multiplexer 620 to output information received directly from the memory unit 700 as opposed the XOR gate 610). In this way, the encryption core receives the current Cᵢ from memory.

Decryption Process: Encryption Core to Memory With Chaining

After the encryption core decrypts the data, the CBC unit 600 will receive data from the encryption core (i.e., input data), combine the received data with previous information (Cᵢ₋₁), and provide the result to memory (i.e., output data Pᵢ).

In this case, it is also arranged for the memory unit 700 to output previous data associated with that encryption core (Cᵢ₋₁) by not asserting the current data or clear signals and selecting the encryption core via the two-bit encryption core select signal. Note that the current data signal may be toggled every time a new data block is loaded.

The output of the memory unit 700 is provided to the XOR gate 610, which also receives current data from the encryption core. The data select signal is then used to instruct the multiplexer 620 to provide information received from the XOR gate 610 (i.e., output data Pᵢ) to memory (as opposed to providing information received directly from the memory unit 700).

Thus, embodiments may provide a single CBC unit 600 capable of supporting multiple encryption cores. Moreover, the CBC unit 600 may be efficiently implemented using a single FPGA slice for each bit of input data.

Additional Embodiments

The following illustrates various additional embodiments. These do not constitute a definition of all possible embodiments, and those skilled in the art will understand that many other embodiments are possible. Further, although the following embodiments are briefly described for clarity, those skilled in the art will understand how to make any changes, if necessary, to the above description to accommodate these and other embodiments and applications.

Although embodiments have been described with respect to a single CBC unit supporting four encryption cores, other configurations can also be used. For example, two CBC units might be used to support eight encryption cores. Moreover, although software or hardware are described as performing certain functions, such functions may be performed using software, hardware, or a combination of software and hardware (e.g., a medium may store instructions adapted to be executed by a processor to perform a method of facilitating an encryption process). For example, functions described herein may be implemented via a software simulation of FPGA hardware.

The several embodiments described herein are solely for the purpose of illustration. Persons skilled in the art will recognize from this description other embodiments may be practiced with modifications and alterations limited only by the claims.

What is claimed is:

1. A device, comprising:
a cipher block chaining unit; and
a plurality of encryption cores, each encryption core being capable of performing an encryption process via the cipher block chaining unit.

2. The device of claim 1, wherein the cipher block chaining unit is implemented via at least one of: (i) a field-programmable gate array, and (ii) an application specific integrated circuit.

3. The device of claim 1, wherein the cipher block chaining unit supports four encryption cores using a single slice of a field-programmable gate array for each bit of input data.

4. The device of claim 1, wherein the cipher block chaining unit comprises, for each bit of input data:
a memory unit,
an XOR gate,
a multiplexer, and
a storage unit.

5. The device of claim 4, wherein the memory unit comprises a random access memory unit.

6. The device of claim 5, wherein the cipher block chaining unit supports four encryption cores and the random access memory unit comprises a 16×1 unit able to store: (i) a current data bit for each encryption core, (ii) a previous data bit for each encryption core, and (iii) eight zero bits.

7. The device of claim 6, wherein the random access memory unit is adapted to receive at least one of the following inputs: (i) data from memory, (ii) a write signal, (ii) an encryption core select signal, (iii) a current data signal, and (iv) a clear signal.

8. The device of claim 4, wherein the XOR gate is adapted to receive at least one of the following inputs: (i) data from an encryption core, and (ii) an output from the memory unit.

9. The device of claim 4, wherein the multiplexer is adapted to receive at least one of the following inputs: (i) an output from the XOR gate, (ii) an output from the memory unit, and (iii) a data select signal.

10. The device of claim 4, wherein the single bit storage unit comprises a digital flip flop register.

11. The device of claim 10, wherein the digital flip flop register is adapted to receive at least one of the following inputs: (i) an output from the multiplexer, and (ii) an enable signal.

12. The device of claim 4, wherein the cipher block chaining unit is adapted to support all of: (i) a transfer from memory to an encryption core with chaining, (ii) a transfer from an encryption core to memory without chaining, (iii) a transfer from memory to an encryption core without chaining, and (iv) a transfer from an encryption core to memory with chaining.

13. The device of claim 4, wherein the cipher block chaining unit supports four encryption cores using a single slice of a field-programmable gate array for each bit of input data and wherein:
the memory unit comprises a function generator,
the XOR gate and multiplexer comprise a lookup table, and
the storage unit comprises a flip flop.

14. The device of claim 1, wherein the encryption cores are adapted to perform at least one of the following: (i) generating a ciphertext output based on a plaintext input and a key, and (ii) generating a plaintext output based on a ciphertext input and a key.

15. The device of claim 1, wherein the encryption process comprises at least one of: (i) a block encryption process, (ii) a data encryption standard process, (iii) a triple data encryption standard process, (iv) an advanced encryption standard process, (v) a cipher block chaining mode, and (vi) a non-chaining mode.

16. A method of facilitating an encryption process, comprising:
receiving input data at a cipher block chaining unit, wherein the cipher block chaining unit is adapted to support a plurality of encryption cores; and
providing output data from the cipher block chaining unit.

17. The method of claim 16, wherein the cipher block chaining unit supports four encryption cores using a single slice of a field-programmable gate array for each bit of input data, and comprises, for each bit of input data:
a 16×1 random access memory unit able to store a current data bit for each encryption core, a previous data bit for each encryption core, and eight zero bits, wherein the memory unit is adapted to receive data from memory, a write signal, a two-bit encryption core select signal, a current data signal, and a clear signal,
an XOR gate adapted to receive data from an encryption core and an output from the memory unit,
a multiplexer adapted to receive an output from the XOR gate, an output from the memory unit, and a data select signal, and
a digital flip flop register adapted to receive an output from the multiplexer and an enable signal.

18. The method of claim 17, wherein the input data is received from memory, the output data is provided to an encryption core with chaining, and further comprising:
receiving data from encryption core at the XOR gate;
copying the received input data to the memory unit by (i) asserting the write signal, (ii) selecting the target encryption core via the two-bit encryption core select signal, (iii) asserting the current data signal, and (iv) not asserting the clear signal; and
routing the output of the XOR gate to the digital flip flop via the data select signal, wherein the output of the digital flip flop is provided to the target encryption core.

19. The method of claim 17, wherein the input data is received from an encryption core, the output data is provided to memory without chaining, and further comprising:
arranging for the data from encryption core to be provided to the multiplexer via the XOR gate by asserting the clear signal to generate a zero bit output from the memory unit; and
routing the output of the XOR gate to memory via the data select signal, wherein the output of the multiplexer is provided to memory.

20. The method of claim 17, wherein the input data is received from memory, the output data is provided to a target encryption core without chaining, and further comprising:
copying the received input data to the memory unit by (i) asserting the write signal, (ii) selecting the target encryption core via the two-bit encryption core select signal, (iii) asserting the current data signal, and (iv) not asserting the clear signal; and
routing the output of the memory unit to the digital flip flop via the data select signal, wherein the output of the digital flip flop is provided to the target encryption core.

21. The method of claim 17, wherein the input data is received from an encryption core, the output data is provided to memory with chaining, and further comprising:
receiving data from encryption core at the XOR gate;
arranging for the memory to provide previous data to the XOR by (i) selecting the appropriate encryption core via the two-bit encryption core select signal, (iii) not asserting the current data signal, and (iv) not asserting the clear signal; and
routing the output of the XOR gate to memory via the data select signal, wherein the output of the multiplexer is provided to memory.

22. A medium storing instructions adapted to be executed by a processor to perform a method of facilitating an encryption process, the method comprising:
receiving input data at a cipher block chaining unit, wherein the cipher block chaining unit is adapted to support a plurality of encryption cores; and
providing output data from the cipher block chaining unit.

23. The medium of claim 22, wherein the cipher block chaining unit is adapted to perform at least one of: (i) a transfer from memory to an encryption core with chaining, (ii) a transfer from an encryption core to memory without chaining, (iii) a transfer from memory to an encryption core without chaining, and (iv) a transfer from an encryption core to memory with chaining.

24. A cipher block chaining unit capable of supporting four encryption cores and comprising, for each bit of input data:
a 16×1 random access memory unit able to store a current data bit for each encryption core, a previous data bit for each encryption core, and eight zero bits, wherein the memory unit is adapted to receive data from memory, a write signal, a two-bit encryption core select signal, a current data signal, and a clear signal;
an XOR gate adapted to receive data from an encryption core and an output from the memory unit;
a multiplexer adapted to receive an output from the XOR gate, an output from the memory unit, and a data select signal; and
a digital flip flop register adapted to receive an output from the multiplexer and an enable signal.

25. The device of claim 24, wherein the cipher block chaining unit uses a single slice of a field-programmable gate array for each bit of input data.
